(19) United States
(12) Patent Application Publication
(10) Pub. No.: US 2012/0032455 A1
(43) Pub. Date: Feb. 9, 2012

(54) Press bar mechanism

(75) Inventor: Ching Tien Lin, Taipei Hsien (TW)

(73) Assignee: Thase Enterprise Co., Ltd.

(21) Appl. No.: 12/806,037

(22) Filed: Aug. 3, 2010

(51) Int. Cl. E05B 65/10

(52) U.S. Cl. 292/92

(57) ABSTRACT

A press bar mechanism includes a latch bolt attached to a housing, a pressing bar attached to the housing and coupled to the latch bolt, a rod received in the housing and coupled to the latch bolt, a casing coupled to the housing and having a chamber for receiving a hydraulic fluid, a piston is engaged in the casing and has one or more fluid flowing orifices, and the piston is smaller than the casing for forming a peripheral passage between the casing and the piston, a piston rod is attached to the piston and coupled to the rod, and a valve member is attached to the piston for blocking the orifices of the piston and for limiting the fluid to flow in one direction relative to the piston, and a spring biases the rod toward the casing for biasing the pressing bar away from the housing.

### BACKGROUND OF THE INVENTION

1. Field of the Invention

The present invention relates to a press bar mechanism for an emergency escape or exit door or fire retardant door and exit device, and more particularly to a press bar mechanism including a buffering or cushioning or damping device for cushioning or damping the movement of the press bar and for preventing the press bar from generating sounds or noises.

2. Description of the Prior Art

Typical emergency escape or exit doors or fire retardant doors and exit devices comprise a press bar mechanism for being actuated by the user to open the emergency escape or exit door or fire retardant door.

For example, U.S. Pat. No. 5,816,017 to Hunt et al., U.S. Pat. No. 6,000,733 to Linder, and U.S. Pat. No. 6,945,571 to Lin disclose three of the typical press bar devices or mechanisms each comprising a press bar carried on a door panel, and coupled to a latch bolt with a crank-coupling mechanism, and/or one or more sliding members, for allowing the press bar to selectively actuate or operate the latch bolt to release or to lock or to unlock the emergency escape or exit doors or fire retardant doors and exit devices.

However, normally, no buffering or cushioning or damping devices or mechanisms have been provided and disposed between the press bar and the emergency escape or exit door, and the press bar may have a good chance to strike onto the emergency escape or exit door and to make or generate sounds or noises when the press bar is released by the user.

The present invention has arisen to mitigate and/or obviate the afore-described disadvantages of the conventional press bar devices or mechanisms for the emergency escape or exit doors or fire retardant doors and exit devices.

### SUMMARY OF THE INVENTION

The primary objective of the present invention is to provide a press bar mechanism including a buffering or cushioning or damping device for cushioning or damping the movement of the press bar and for preventing the press bar from generating sounds or noises.

In accordance with one aspect of the invention, there is provided a press bar mechanism comprising a housing, a latch bolt slidably attached to the housing, a pressing bar slidably attached to the housing and movable toward the housing and coupled to the latch bolt for selectively retracting the latch bolt into the housing, a rod slidably received in the housing and coupled to the latch bolt for selectively retracting the latch bolt into the housing, and including an extension extended therefrom, a hydraulic buffering device including a casing having a first end coupled to the housing and having a chamber formed in the casing for receiving a hydraulic fluid therein, a piston slidably engaged in the chamber of the casing and movable toward or away from the first end of the casing, the piston including at least one orifice formed therein for allowing the fluid to selectively flow through the orifice of the piston, and the piston including an outer diameter smaller than an inner diameter of the casing for forming a peripheral passage between the casing and the piston and for allowing the fluid to selectively flow through the peripheral passage that is formed between the casing and the piston, a piston rod attached to the piston and extended out of the casing and coupled to the extension of the rod for allowing the piston rod and the piston to be moved relative to the casing by the rod, and a valve member attached to the piston for selectively blocking the orifice of the piston and for preventing the fluid from flowing back through the orifice of the piston, and a spring biasing member for biasing the rod toward the casing and the latch bolt and for biasing the pressing bar away from the housing, the extension of the rod is moved away from the casing, and the piston being moved away from the first end of the casing by the piston rod and the rod when the pressing bar is depressed and moved toward the housing, and the extension of the rod is moved toward the first end of the casing when the pressing bar is released such that the movement of the press bar may be cushioned and such that the press bar may be prevented from generating sounds or noises.

The housing includes a frame disposed and secured therein, and the first end of the casing is pivotally secured to the frame with a pivot axle.

The housing includes a crank pivotally coupled to the frame and pivotally coupled to the latch bolt with a link and pivotally coupled to the pressing bar.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial cross sectional view of a press bar mechanism in accordance with the present invention;

FIG. 2 is a partial cross sectional view similar to FIG. 1, illustrating the operation of the press bar mechanism;

FIG. 3 is a partial exploded view illustrating a portion of the press bar mechanism;

FIG. 4 is a perspective view illustrating the portion of the press bar mechanism as shown in FIG. 3;

FIG. 5 is a perspective view illustrating a hydraulic buffering or cushioning or damping device of the press bar mechanism;

FIG. 6 is a cross sectional view of the hydraulic buffering or cushioning or damping device, taken along lines 6-6 of FIG. 5;

FIG. 7 is an enlarged partial cross sectional view of the hydraulic buffering or cushioning or damping device of the press bar mechanism;

FIG. 8 is another cross sectional view similar to FIG. 6, illustrating the operation of the hydraulic buffering or cushioning or damping device of the press bar mechanism; and

FIG. 9 is an enlarged partial cross sectional view of the hydraulic buffering or cushioning or damping device as shown in FIG. 8.

### DETAILED DESCRIPTION OF THE PREFERRED EMBODIMENT

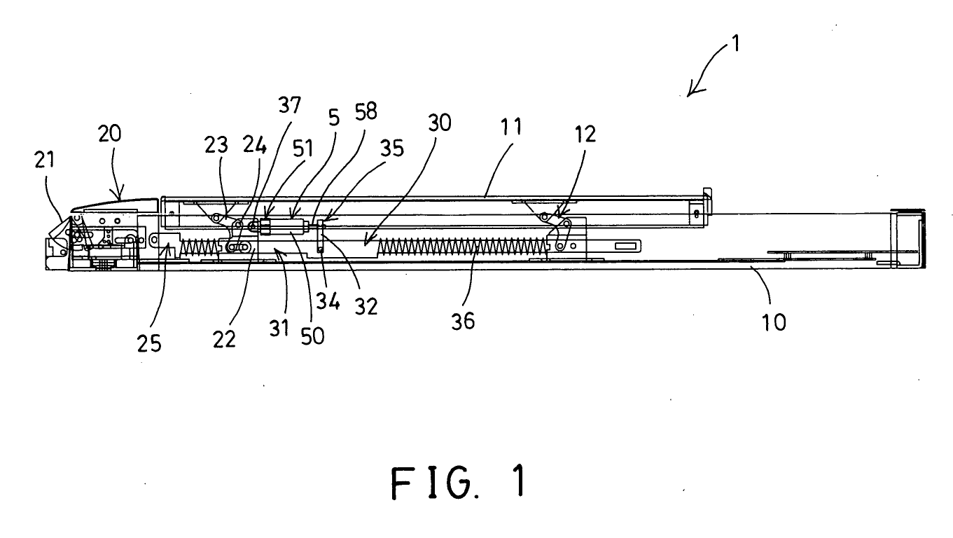

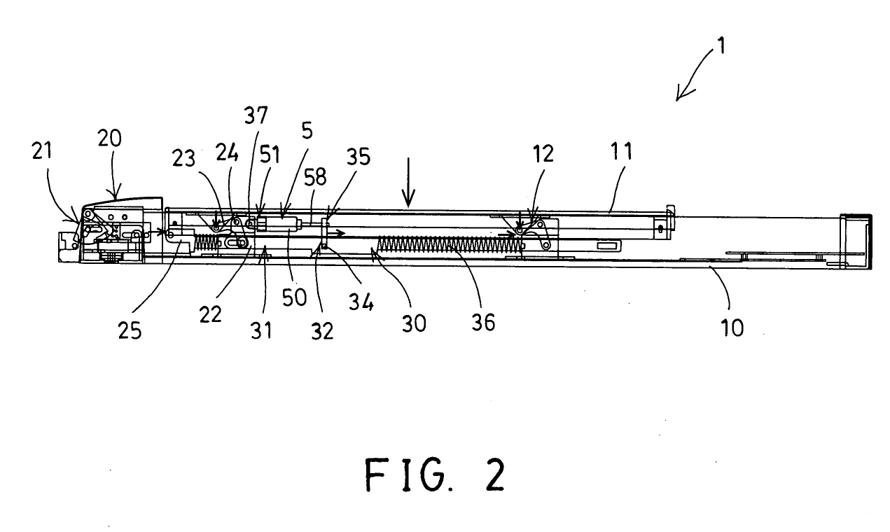

Referring to the drawings, and initially to FIGS. 1 and 2, a press bar mechanism 1 in accordance with the present invention comprises a base or housing 10 for attaching to an emergency escape door or fire retardant door and exit device or exit door panel (not shown), and a pressing bar 11 slidably attached to the housing 10 and movable or depressible toward the housing 10 for being selectively depressed or actuated by the user, and one or more coupling or spring members 12 disposed or attached between the pressing bar 11 and the exit door panel for biasing or forcing the pressing bar 11 away from the exit door panel and the housing 10 when the pressing bar 11 is released by the user.

A lock device 20 is attached to the housing 10 and includes a latch bolt 21 for selectively releasing or locking or unlocking the exit door panel, and includes a frame 22 disposed or attached or secured to the housing 10, a crank 23 rotatably or pivotally coupled to the frame 22 or the housing 10 with a pivot axle 24 and pivotally coupled to the latch bolt 21 with a link 25 and also pivotally coupled to the pressing bar 11 for allowing the latch bolt 21 to be selectively moved or retracted into the housing 10 when the pressing bar 11 is depressed toward the housing 10 by the user, and for allowing the exit door panel to be selectively opened. The above-described structure or arrangement is typical and will not be described in further details.

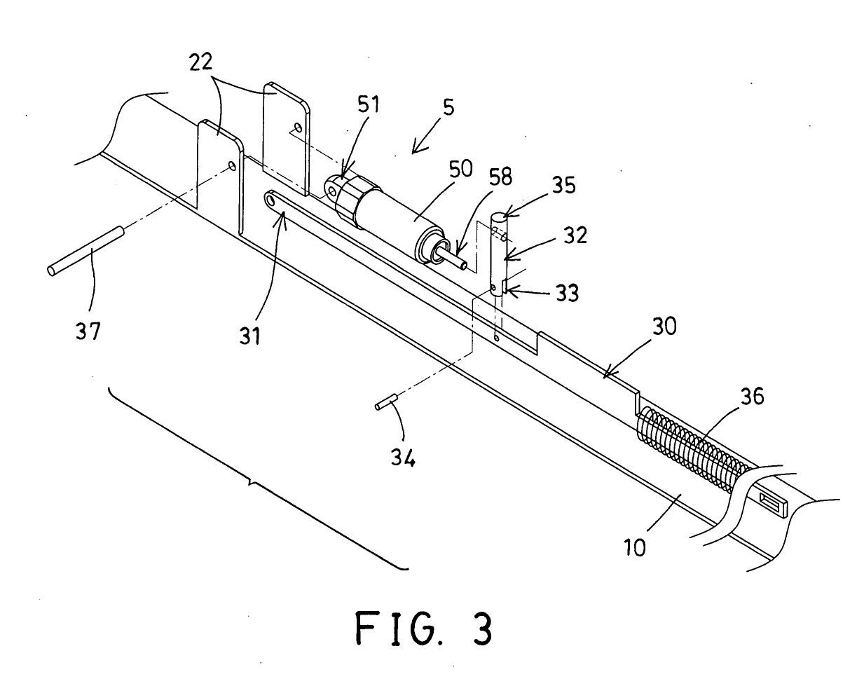

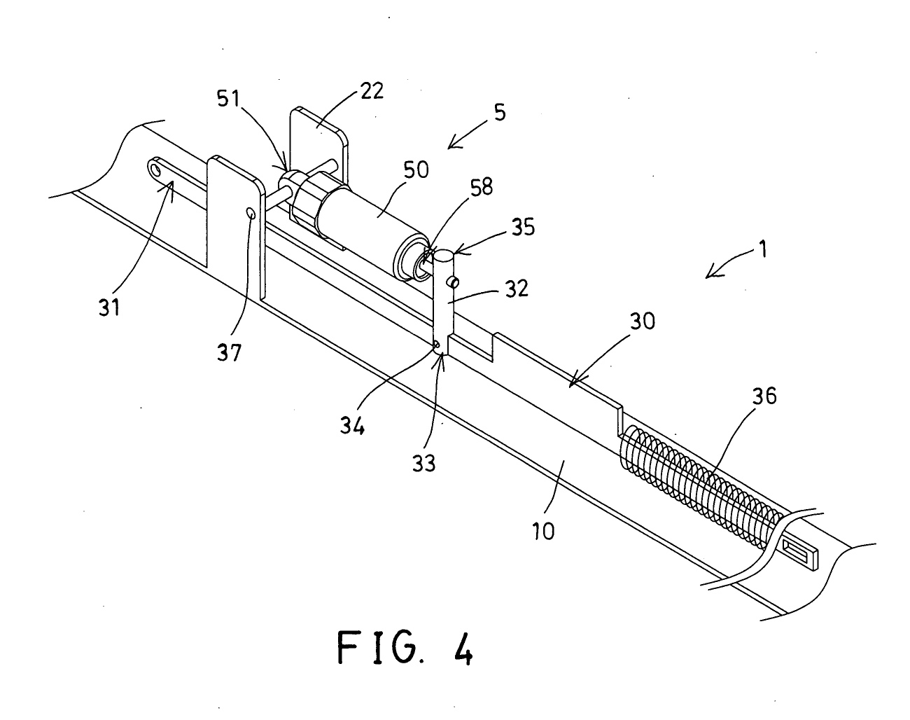

As shown in FIGS. 1-4, a longitudinal beam or rod 30 is slidably received in the housing 10, and includes one end 31 pivotally coupled to the crank 23 and/or the link 25 and/or the latch bolt 21 to selectively move or retract the latch bolt 21 into the housing 10, and includes a stop or plate or extension 32 extended radially or outwardly from the rod 30, or the extension 32 includes one end 33 attached or mounted or secured to the rod 30 with one or more latches or fasteners 34 and includes another end 35 located or extended away from the rod 30. A spring biasing member 36 may further be provided and engaged with or between the rod 30 and the housing 10 for biasing the rod 30 toward the lock device 20 and the latch bolt 21, and for biasing the latch bolt 21 to engage with the exit door panel, and also for biasing the pressing bar 11 away from the housing 10.

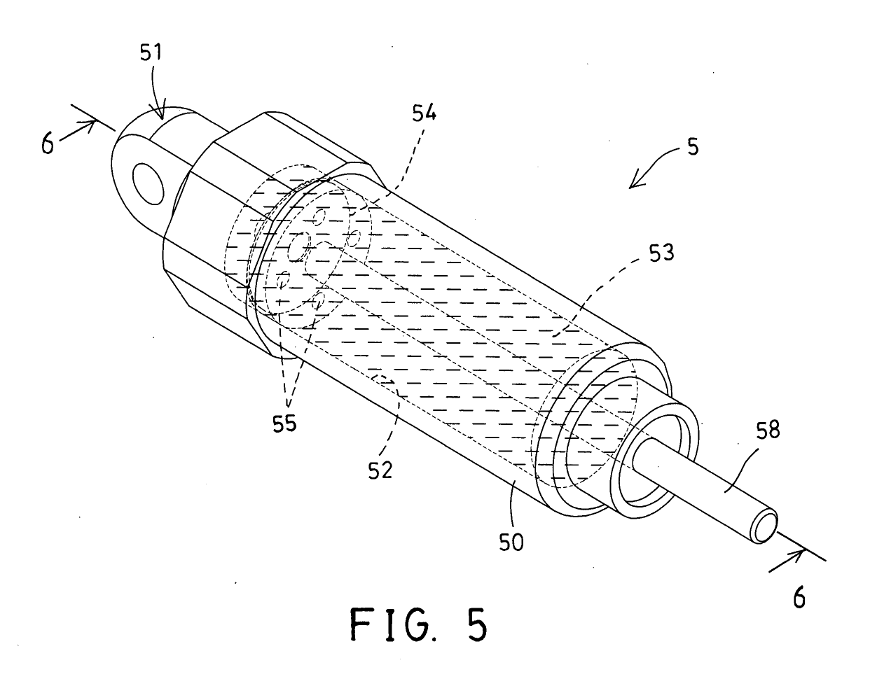

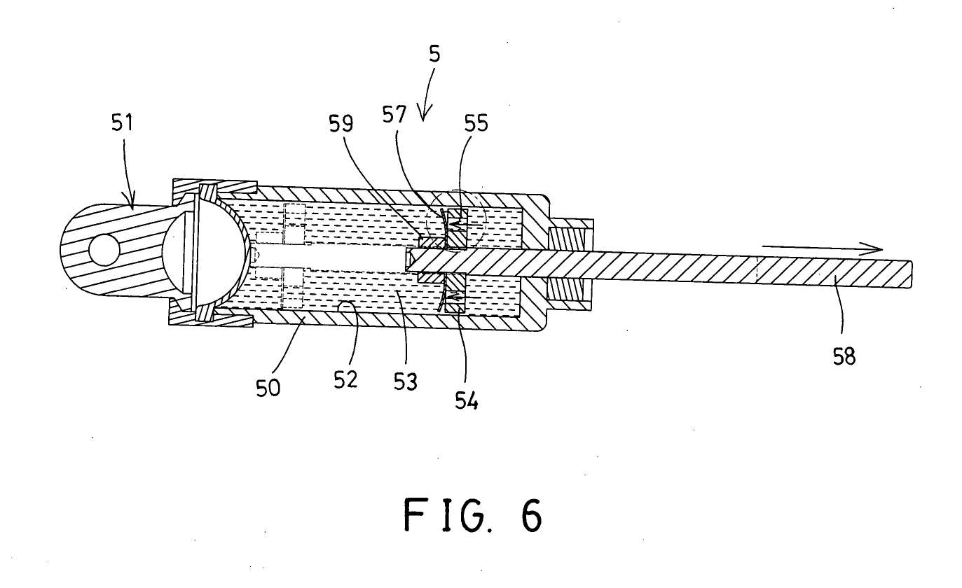

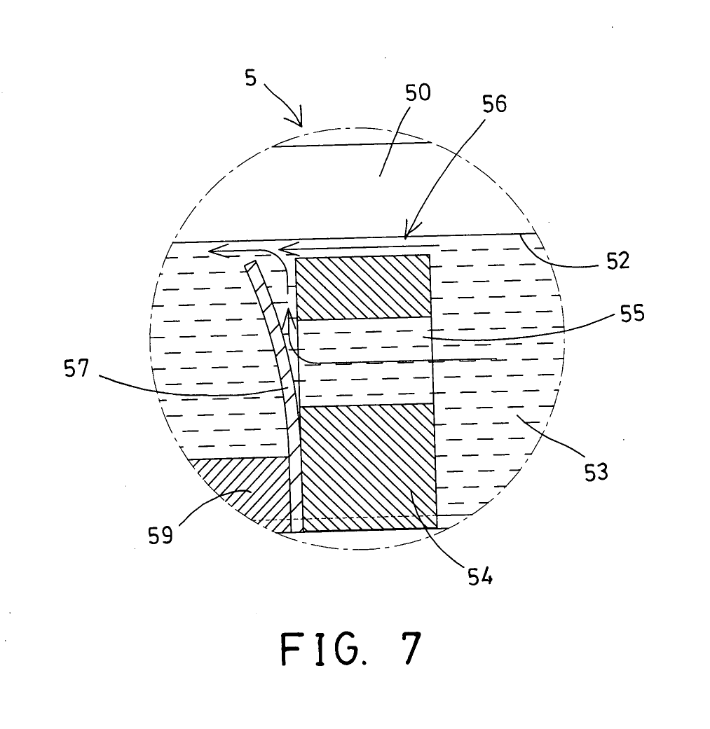

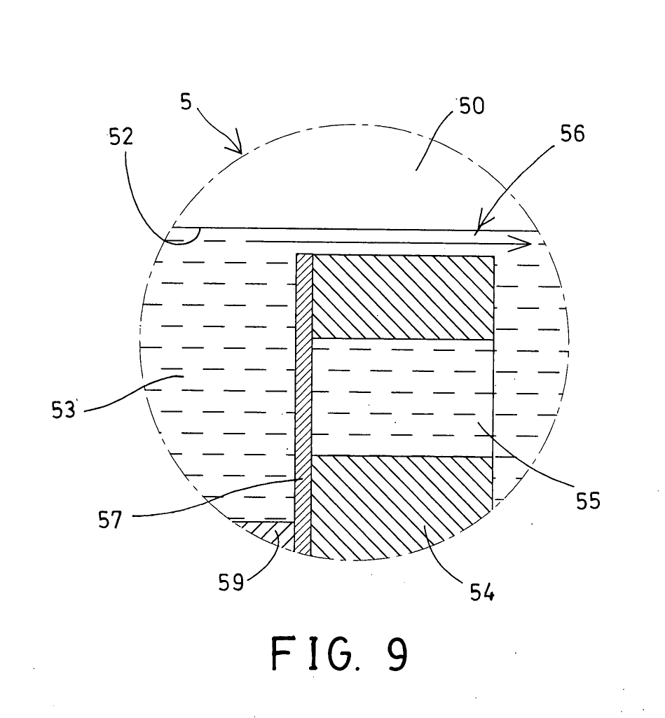

A hydraulic buffering or cushioning or damping device 5 is further be provided and includes a cylindrical casing 50 having one end or first end 51 pivotally or rotatably attached or mounted or secured or coupled to the housing 10, such as coupled to the frame 22 of the housing 10 with a pivot axle 37, as shown in FIGS. 5-9, the casing 50 includes a bore or chamber 52 formed therein for receiving a hydraulic oil or fluid 53 therein. A piston 54 is slidably received or engaged in the chamber 52 of the casing 50 and movable toward or away from the first end 51, and includes one or more orifices 55 formed therein for allowing the fluid 53 to selectively flow through the orifices 55 of the piston 54 (FIGS. 6, 7), and includes an outer diameter slightly smaller than the inner diameter of the casing 50 for forming or defining a peripheral gap or passage 56 between the casing 50 and the piston 54 (FIGS. 7, 9) and for also allowing the fluid 53 to selectively flow in either direction through the peripheral passage 56 that is formed between the casing 50 and the piston 54.

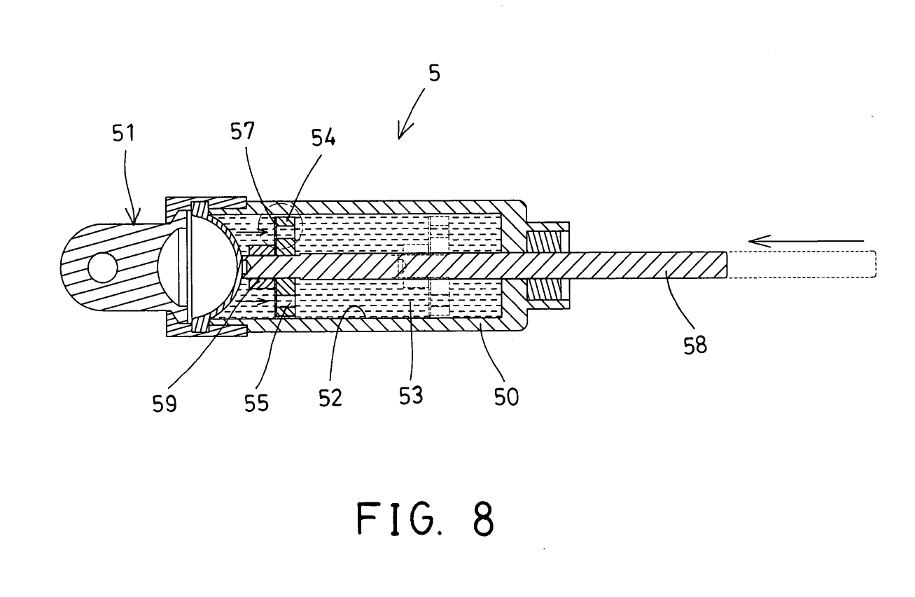

A spring blade or check valve member 57 is attached or mounted or secured to the piston 54 with a piston rod 58 and a fastener 59 for selectively blocking the orifices 55 of the piston 54 (FIGS. 8, 9) and for preventing the fluid 53 from flowing through the orifices 55 of the piston 54, such that the spring blade or check valve member 57 may act as a spring biasing means or check valve means or device for limiting the fluid 53 to selectively flow through the orifices 55 of the piston 54 in one direction only and for preventing the fluid 53 from flowing through the orifices 55 of the piston 54 in the other or opposite direction. The piston rod 58 has a free end or outer end extended out of the casing 50 and attached or mounted or secured or coupled to the upper or other end 35 of the extension 32 of the rod 30 for allowing the piston rod 58 and the piston 54 to be moved relative to the casing 50 by the extension 32 of the rod 30.

In operation, as shown in FIG. 2, when the pressing bar 11 is selectively depressed or actuated by the user and moved toward the housing 10, the latch bolt 21 may be selectively moved or retracted into the housing 10 by the crank 23, and simultaneously, the rod 30 may be selectively moved away from the lock device 20 by the crank 23, and the extension 32 of the rod 30 may also be moved away from the lock device 20 and the casing 50 of the buffering or cushioning or damping device 5. At this moment, the piston 54 may be moved or pulled or forced to move away from the lock device 20 by the piston rod 58 and may be moved slowly by the spring biasing member 36 and by the buffering and flowing of the fluid 53 through the orifices 55 of the piston 54 (FIGS. 6, 7).

When the pressing bar 11 is released by the user, as shown in FIG. 1, the pressing bar 11 may be moved or forced or biased away from the exit door panel and the housing 10 by the spring biasing member 36, and the latch bolt 21 may be moved or forced out of the housing 10 to engage with the exit door panel and to lock the exit door panel. At this moment, the extension 32 of the rod 30 may be moved or forced to engage with the piston rod 58 and to force the piston 54 to move toward the first end 51 of the casing 50 and to move toward the lock device 20 and the latch bolt 21. At this moment, the spring blade or check valve member 57 may block the orifices 55 of the piston 54 (FIGS. 8, 9) and may prevent the fluid 53 from flowing through the orifices 55 of the piston 54, and the fluid 53 may selectively flow through the peripheral passage 56 that is formed between the casing 50 and the piston 54, such that the hydraulic buffering or cushioning or damping device 5 may be provided for buffering or cushioning or damping or slowing the movement of the press bar 11 and for preventing the press bar 11 from generating sounds or noises.

Accordingly, the press bar mechanism in accordance with the present invention includes a buffering or cushioning or damping device for cushioning or damping or slowing the movement of the press bar and for preventing the press bar from generating sounds or noises.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A press bar mechanism comprising:
a housing,
a latch bolt slidably attached to said housing,
a pressing bar slidably attached to said housing and movable toward said housing and coupled to said latch bolt for selectively retracting said latch bolt into said housing,
a rod slidably received in said housing and coupled to said latch bolt for selectively retracting said latch bolt into said housing, and including an extension extended therefrom,
a hydraulic buffering device including a casing having a first end coupled to said housing and having a chamber formed in said casing for receiving a hydraulic fluid therein, a piston slidably engaged in said chamber of said casing and movable toward or away from said first end of said casing, said piston including at least one orifice formed therein for allowing the fluid to selectively flow through said at least one orifice of said piston, and said piston including an outer diameter smaller than an inner diameter of said casing for forming a peripheral passage between said casing and said piston and for allowing the fluid to selectively flow through said peripheral passage that is formed between said casing and said piston, a piston rod attached to said piston and extended out of said casing and coupled to said extension of said rod for allowing said piston rod and said piston to be moved relative to said casing by said rod, and a valve member attached to said piston for selectively blocking said at least one orifice of said piston and for preventing the fluid from flowing back through said at least one orifice of said piston, and
a spring biasing member for biasing said rod toward said casing and said latch bolt and for biasing said pressing bar away from said housing,
said extension of said rod being moved away from said casing, and said piston being moved away from said first end of said casing by said piston rod and said rod when said pressing bar is depressed and moved toward said housing, and said extension of said rod being moved toward said first end of said casing when said pressing bar is released.

2. The press bar mechanism as claimed in claim 1, wherein said housing includes a frame disposed and secured therein, and said first end of said casing is secured to said frame with a pivot axle.

3. The press bar mechanism as claimed in claim 2, wherein said housing includes a crank pivotally coupled to said frame and pivotally coupled to said latch bolt with a link and pivotally coupled to said pressing bar.
